(19) United States
(12) Patent Application Publication
(10) Pub. No.: US 2007/0245569 A1
(43) Pub. Date: Oct. 25, 2007

(54) Belt cutter with safety retractable blades

(76) Inventor: Hsiu-Man Yu Chen, Taichung (TW)

Correspondence Address: BRUCE H. TROXELL, SUITE 1404, 5205 LEESBURG PIKE, FALLS CHURCH, VA, 22041, US

(21) Appl. No.: 11/410,081

(22) Filed: Apr. 25, 2006

(51) Int. Cl. B26B 11/00; B26B 1/08

(52) U.S. Cl. 30/143; 30/162

(57) ABSTRACT

A belt cutter with safety retractable blades includes a shell composed of an upper hell and a lower shell. The shell is provided inside with a retractable cutter set consisting of a slide block, a cutting blade and a push button. The slide block and the cutting blade are axially installed in the shell, and the push button is positioned at the outer side of the shell for pushing the slide block and the cutting blade to shift. Additionally, an elastic member is engaged on the retractable cutter set. When the push button is pushed backward, the cutting blade will be actuated to extend out of shell, and when the push button is released, the elastic member will recover its elastic force and actuate the cutting blade to move back to interior of the shell, insuring safety in use.

### BACKGROUND OF THE INVENTION

1. Field of the Invention

This invention relates to a belt cutter with safety retractable blades, particularly to one provided with a retractable cutter set with a cutting blade able to be actuated by the elasticity of an elastic member to automatically move back to the interior of a shell body with a push button released, when the cutting blade is not to be used.

2. Description of the Prior Art

A conventional belt cutter, as shown in FIG. 1, includes a shell 1, a first movable cutter 2, a second movable cutter 3 and a cutter protecting cover 4. The shell 1 has its front end cut with a lengthwise aperture 5, and the first movable cutter 2 is received in the shell 1 and has its blade edge exposed outward for cutting off a belt positioned in the aperture 5. The second movable cutter 3 is provided at the opposite side of the aperture 5 of the shell 1 and extends out of the rear end of the shell 1 for cutting off the belt positioned at the inner side of the blade edge. The cutter protecting cover 4 is movably covered on the second movable cutter 3 for protection.

However, the second movable cutter 3 of the conventional belt cutter is provided to protrude out of the shell; therefore, once the cutter protecting cover 4 pivotally assembled at the outer side of the shell 1 should fall off or fail to cover the second movable cutter 3, the second movable cutter 3 will be exposed outward and may be bumped and damaged, and even worse, may cause an accident of hurting people.

### SUMMARY OF THE INVENTION

The objective of the invention is to offer a belt cutter with safety retractable blades, which includes a shell composed of an upper shell and a lower shell. The upper shell has its rear inner side formed with an axial slide groove having one side pivotally fitted with an elastic member. The lower shell has its rear end formed with an open-end cutter recess for receiving a retractable cutter set, which consists of a slide block, a cutting blade and a push button. The slide block is slidably positioned in the slide groove of the upper shell, while the cutting blade is fitted in the cutter recess of the lower shell. The push button is movably assembled at the outer side of the push groove of the lower shell and firmly connected with the cutting blade and the slide block, and the elastic member has one end pivotally connected with the retractable cutter set. In using, when the push button is pushed to move the retractable cutter set backward, the cutting blade of the retractable cutter set will be actuated to extend out of the rear end of the shell and the elastic member will produce an elastic restoring force. When the push button is released, the retractable cutter set will be moved back to the interior of the shell by the elasticity of the elastic member. By so designing, when the cutting blade of the retractable cutter set is not in use, it will be automatically moved to the interior of the shell body, thus insuring safety in using the belt cutter.

### BRIEF DESCRIPTION OF DRAWINGS

This invention will be better understood by referring to the accompanying drawings, wherein:

FIG. 1 is a cross-sectional view of a conventional belt cutter;

FIG. 2 is a perspective view of a first preferred embodiment of a belt cutter with safety retractable blades in the present invention;

FIG. 3 is an exploded perspective view of the first preferred embodiment of a belt cutter with safety retractable blades in the present invention;

FIG. 4 is a cross-sectional view of the first preferred embodiment of a belt cutter with safety retractable blades in the present invention;

FIG. 5 is a cross-sectional view of the first preferred embodiment of a belt cutter with safety retractable blades in an operating condition in the present invention;

FIG. 6 is a perspective view of the first preferred embodiment of a belt cutter with safety retractable blades in an operating condition held in a hand in the present invention; and

FIG. 7 is a side cross-sectional view of a second preferred embodiment of a belt cutter with safety retractable blades in the present invention.

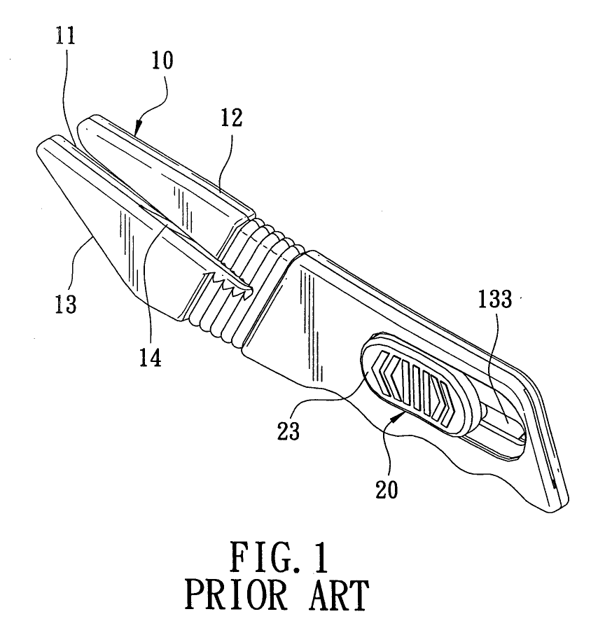

### DETAILED DESCRIPTION OF THE PREFERRED EMBODIMENT

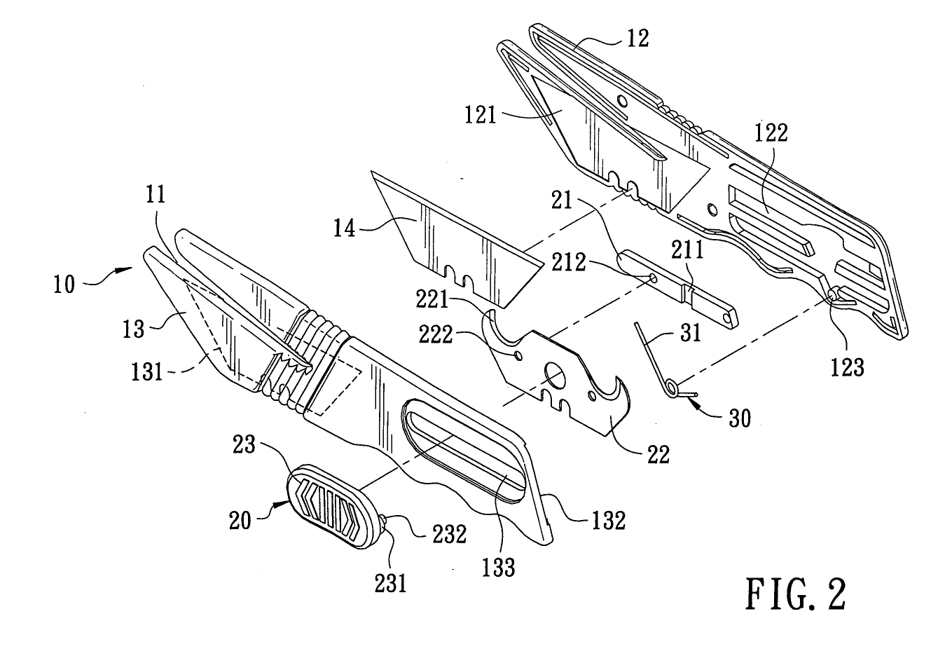

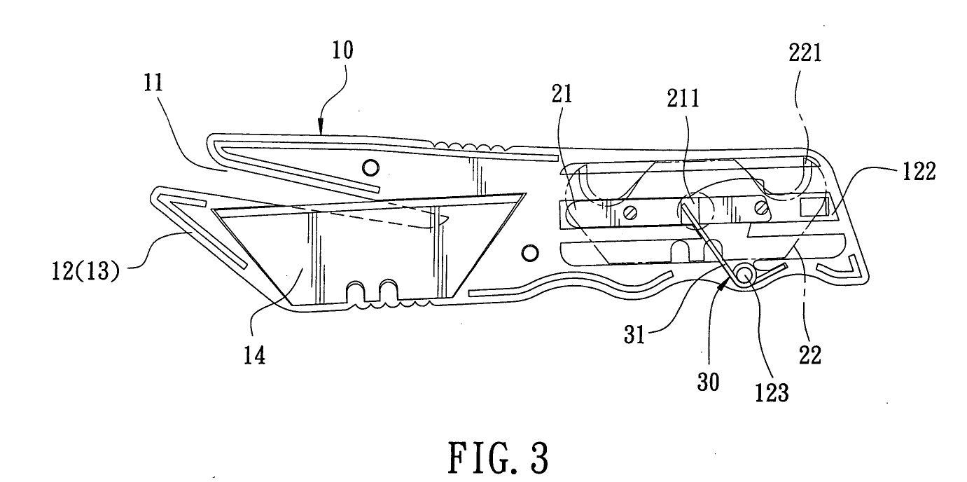

A first preferred embodiment of a belt cutter with safety retractable blades in the present invention, as shown in FIGS. 2, 3 and 4, includes a shell 10, a retractable cutter set 20 and an elastic member 30 combined together.

The shell 10 composed of an upper shell body 12 and a lower shell body 13 has its front end formed with a cutting aperture 11. The upper and the lower shell body 12, 13 have their interiors respectively bored with an upper accommodating groove 121 and a lower accommodating groove 131 at the same end of the cutting aperture 11 for receiving a blade 14 whose blade edge is oblique from the cutting aperture 11 at a preset angle. Further, the upper shell 12 has its rear inner side formed with an axial slide groove 122 having one side fixed with a pivot 123, and the lower shell body 13 has its rear end bored with an open-end cutter recess 132 corresponding to the slide groove 122 of the upper shell 12 and has the outer side of the cutter recess 132 bored with a push groove 133 communicating with the slide groove 122 of the upper shell 12.

The retractable cutter set 20 consists of a slide block 21, a cutting blade 22 and a push button 23. The slide block 21 is slidably positioned in the slide groove 122 of the upper shell 12, able to be shifted back and forth axially in the slide groove 122, and is cut with an engage recess 211 at the upper side and two insert holes 212 respectively at the opposite sides of the engage recess 211. The cutting blade 22 slidably positioned in the cutter slot 132 has its opposite ends respectively formed with a blade edge 221 and is bored with two combining holes 222 respectively matching with the two insert holes 212 of the slide block 21. The push button 23 provided with a push rod 231 is movably assembled at the outer side of the push groove 133 by its push rod 231, which has its inner side secured with two engage buttons 232 to be firmly connected with the cutting blade 22 and the slide block 21.

The elastic member 30 pivotally fitted with the pivot 123 of the upper shell 12 is a torsion spring having one end extending outward to form an elastic end 31 to be elastically engaged in the engage recess 211 of the slide block 21.

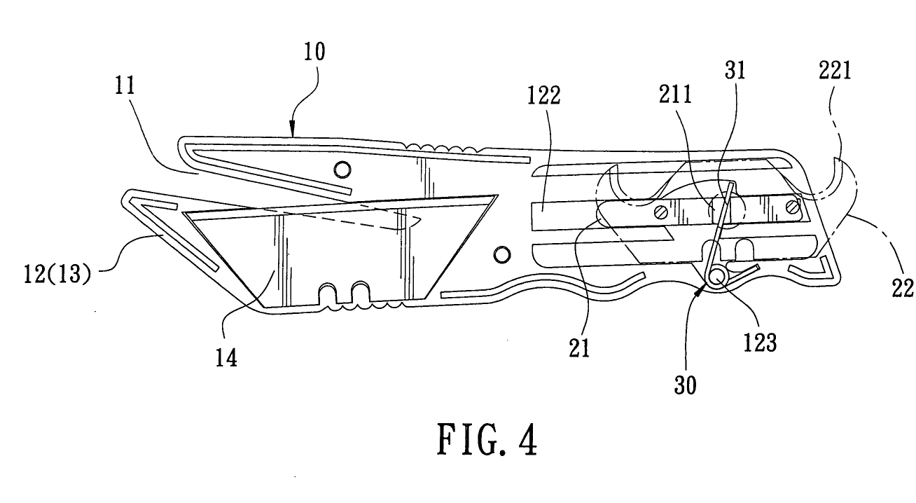

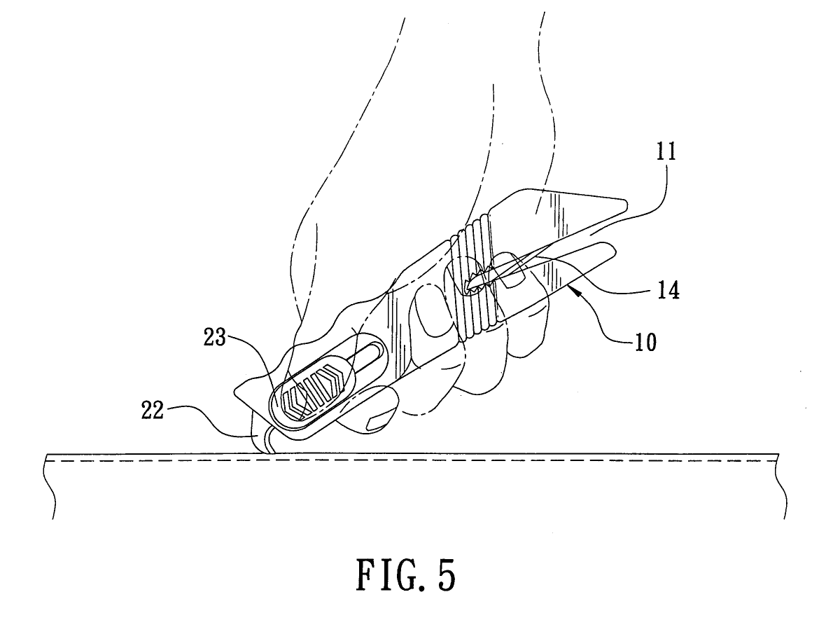

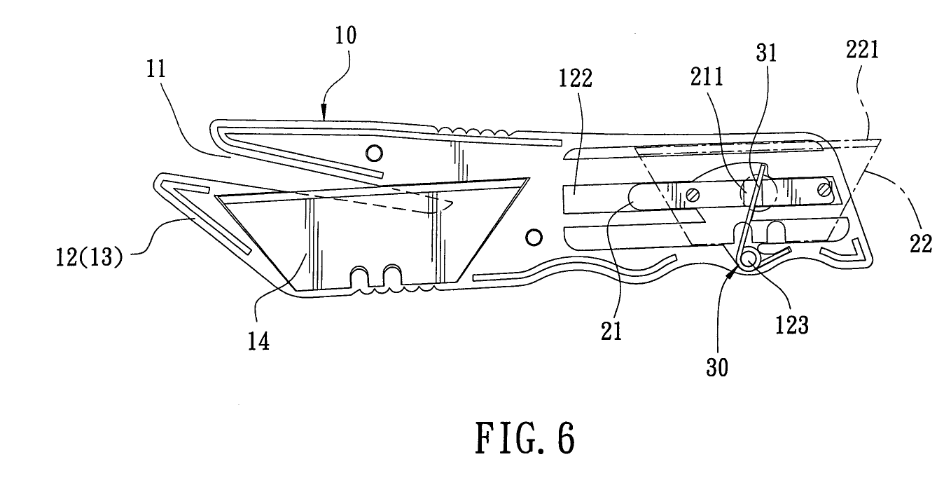

In using, as shown in FIGS. 4, 5 and 6, when a comparatively hard belt, such as packaging belt, is to be cut off, the belt is placed in the cutting aperture 11 and cut off by the blade 14. When the retractable cutter set 20 is to be used, the push button 23 has to be pushed to move backward the cutting blade 22 and the slide block 21, letting the cutting blade 22 extend out of the rear end of the shell 10 to carry out cutting work with its blade edge 221. At this time, the elastic end 31 of the elastic member 30 will be moved backward together with the slide block 21 to produce an elastic restoring force. After the cutting blade 22 finishes cutting work and the push button 23 is released, the elastic end 31 of the elastic member 30 will recover its elasticity and actuate both the slide block 21 and the cutting blade 22 to move back to the interior of the shell 10. Thus, when the cutting blade 22 is not to be used, it will be positioned in the interior of the shell 10, preventing the cutting blade 22 from causing an accident of hurting people or being damaged by falling off.

A second preferred embodiment of a belt cutter with safety retractable blades in the present invention, as shown in FIG. 7, has almost the same structure as that of the first preferred embodiment, except that the cutting blade 22 has it blade edge 221 provided at one side. Thus, different kinds of blade edges can be formed on the cutting blades 22 changeably uses to meet different needs, enabling the belt cutter to be used extensively.

By so designing, the cutting blades of the belt cutter of this invention can be automatically moved back to the interior of the shell body to prevent the cutting blades from hurting people or being damaged in case of falling off, able to insure safety in use and prolong service life of the belt cutter.

While the preferred embodiments of the invention have been described above, it will be recognized and understood that various modifications may be made therein and the appended claims are intended to cover all such modifications that may fall within the spirit and scope of the invention.

I claim:

1. A belt cutter with safety retractable blades comprising:
A shell composed of an upper shell and a lower shell, said upper shell having its rear inner side formed with a slide groove, said upper shell provided with a pivot at one side of said slide groove, said lower shell bored at the rear end with an open-end cutter recess corresponding to said slide groove of said upper shell body, said lower shell having the outer side of said cutter recess bored with a push groove communicating with said slide groove of said upper shell:
A retractable cutter set composed of a slide block, a cutting blade and a push button, said slide block slidably positioned in said slide groove of said upper shell body and able to be shifted back and forth axially in said slide groove, said cutting blade slidably fitted in said cutter recess of said lower shell, said push button assembled at the outer side of said push groove of said lower shell body and fixedly connected with said cutting blade and slide block: and
An elastic member pivotally fitted on said pivot of said upper shell body and having its elastic end extending outward and engaged on said retractable cutter set.

2. The belt cutter with safety retractable blades as claimed in claim 1, wherein said slide block has its upper side cut with an engage recess for said elastic end of said elastic member to be engaged therein.

3. The belt cutter with safety retractable blades as claimed in claim 1, wherein said elastic member is a torsion spring.

4. The belt cutter with safety retractable blades as claimed in claim 1, wherein said retractable blade has the opposite ends respectively formed with a hook blade edge.

5. The belt cutter with safety retractable blades as claimed in claim 1, wherein said retractable blade has one side formed with a blade edge.
